(19) United States
(12) Patent Application Publication
(10) Pub. No.: US 2017/0277259 A1
(43) Pub. Date: Sep. 28, 2017

(54) EYE TRACKING VIA TRANSPARENT NEAR EYE LENS

(71) Applicant: DAQRI, LLC, Los Angeles, CA (US)

(72) Inventors: Brian Mullins, Altadena, CA (US); Ryan Ries, La Canada, CA (US)

(21) Appl. No.: 15/468,470

(22) Filed: Mar. 24, 2017

Related U.S. Application Data
(60) Provisional application No. 62/312,813, filed on Mar. 24, 2016.

(51) Int. Cl. G06F 3/01; G02B 27/00; F21V 8/00; G02B 27/01

(52) U.S. Cl. CPC G06F 3/013; G02B 27/0172; G02B 27/0093; G02B 6/0066; G02B 2027/014; G02B 2027/0174

(57) ABSTRACT

A head mounted device includes a transparent display, an infrared light source, and an infrared light receiver. The transparent display has a transparent waveguide and a first and second optical component connected to the transparent waveguide. The infrared light source generates an infrared light directed at the second optical component. The transparent waveguide receives the infrared light from the second optical component and transmits the infrared light to the first optical component. The first optical component directs the infrared light to an eye of a user of the head mounted device and receives a reflection of the infrared light off the eye of the user. The infrared light receiver receives the reflection of the infrared light via the second optical component and generates reflection data based on the received reflection of the infrared light. A position of the eye of the user is identified based on the reflection data.

### REFERENCE TO RELATED APPLICATION

This application claims the benefit of priority of U.S. Provisional Application No. 62/312,813 filed Mar. 24, 2016, which is herein incorporated by reference in its entirety.

### TECHNICAL FIELD

The subject matter disclosed herein generally relates to an augmented or mixed reality display device. Specifically, the present disclosure addresses systems and methods for an eye tracking system via a transparent near eye lens.

### BACKGROUND

Head mounted display devices such as eyeglasses allow users to observe a scene while simultaneously seeing relevant virtual content on item, images, objects, or environments in the field of view of the device or user. However, tracking the position of the eyes of a user in a head mounted device can be difficult because it requires placing multiple sensors and light sources around the eye of the user within a confined limited space of the head mounted device. The large number of components and their different locations in the head mounted device can render the manufacturing and operation of the head mounted device complicated.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an example of a network environment suitable for an augmented or mixed reality system, according to some example embodiments.

FIG. 2 is a block diagram illustrating an example embodiment of components of a mobile device.

FIG. 3A is a block diagram illustrating a first example embodiment of a display system.

FIG. 3B is a block diagram illustrating a second example embodiment of a display system.

FIG. 3C is a block diagram illustrating a third example embodiment of a display system.

FIG. 3D is a block diagram illustrating an example embodiment of a head mounted device with a transparent near eye lens.

FIG. 4 is a block diagram illustrating an example embodiment of an eye tracking module.

FIG. 5 is a block diagram illustrating an example embodiment of a server.

FIG. 6 is a flow diagram illustrating a method for calculating an eye position using a transparent near eye lens in accordance with one embodiment.

FIG. 7 is a flow diagram illustrating a method for displaying an image based on an eye position using a transparent near eye lens in accordance with one embodiment.

FIG. 8 is a flow diagram illustrating a method for manufacturing a display system with a transparent near eye lens in accordance with one embodiment.

FIG. 9 is a flow diagram illustrating another method for manufacturing a display system with a transparent near eye lens in accordance with one embodiment.

FIG. 10 a block diagram illustrating components of a machine, according to some example embodiments, able to read instructions from a machine-readable medium and perform any one or more of the methodologies discussed herein.

FIG. 11 a block diagram illustrating components of a mobile device, according to some example embodiments, able to read instructions from a machine-readable medium and perform any one or more of the methodologies discussed herein.

### DETAILED DESCRIPTION

Example methods and systems are directed as an augmented or mixed reality display device. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, a head mounted device includes a transparent display for displaying augmented or mixed reality content and for detecting and tracking a position of an eye of the user of the device. The head mounted device includes a transparent waveguide, a first and second optical component connected to the transparent waveguide, an infrared light source, a light receiver, and a processor. The infrared light source generates an infrared light directed at the second optical component. The infrared light travels from the second optical component through the transparent waveguide to the first optical component. The first optical coupler transmits the infrared light to an eye of the user of the head mounted device and receives a reflection of the infrared light from the eye of the user. The reflected infrared light travels from the first optical component through the transparent waveguide to the second optical component. The light receiver receives the reflection of the infrared light from the second optical component and generates reflection data based on the received reflection of the infrared light. The processor includes an eye tracking application configured to receive the reflection data from the light receiver and to identify a position of the eye of the user based on the reflection data.

It is noted that the first optical component is positioned in front of the eye of the user and in a line of sight of the user such that the user looks through the first optical component when using the device. In another example, the first optical component may be positioned adjacent and above the eyes of the user. The first optical component may be positioned so that the infrared light is directed towards the eyes of the user. The optical components are also referred to as optical coupler in the present application. The optical components enable light to enter and exit the transparent waveguide. For example, light enters the transparent waveguide via the second optical component, travels through the transparent waveguide, and exits via the first optical component. Examples of optical component includes, and are not limited to, a lens, a prism, or a hologram. The optical component allow light to enter and exit in a perpendicular direction to a plane of the transparent waveguide (e.g., in a similar manner to a periscope).

In another example embodiment, a display system generates an image of a virtual object and utilizes the same first optical component to shine the image into the eyes of the user. Therefore, the first optical component may be used for directing infrared light into the eyes of the user, receiving infrared light reflected from the eyes of the user, and directing visible light (forming the image of the virtual object) into the eyes of the user.

Augmented reality includes augmented virtual objects in real world. For example, a user may perceive virtual object rendered as a layer on top of real world physical objects. Mixed reality include a mix of virtual reality and augmented reality where physical and digital objects co-exist and interact in real time. For example, a user can navigate through a real world with the use of virtual objects.

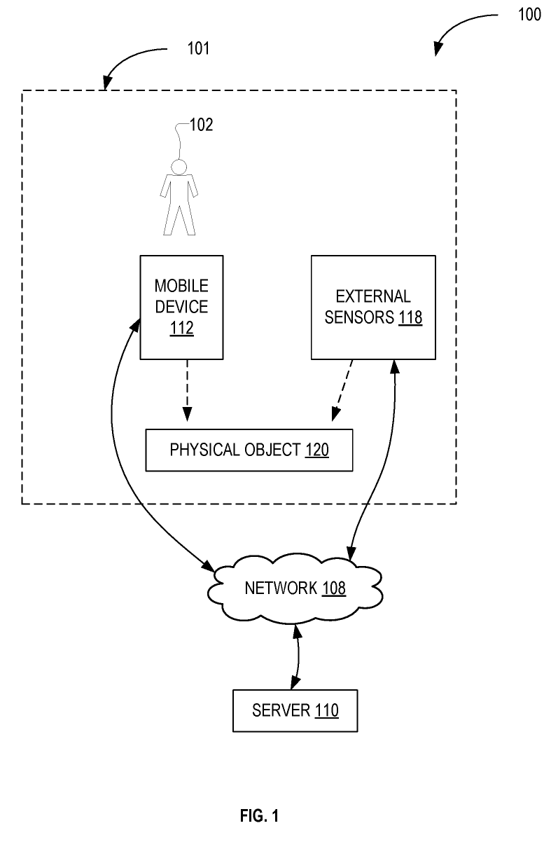

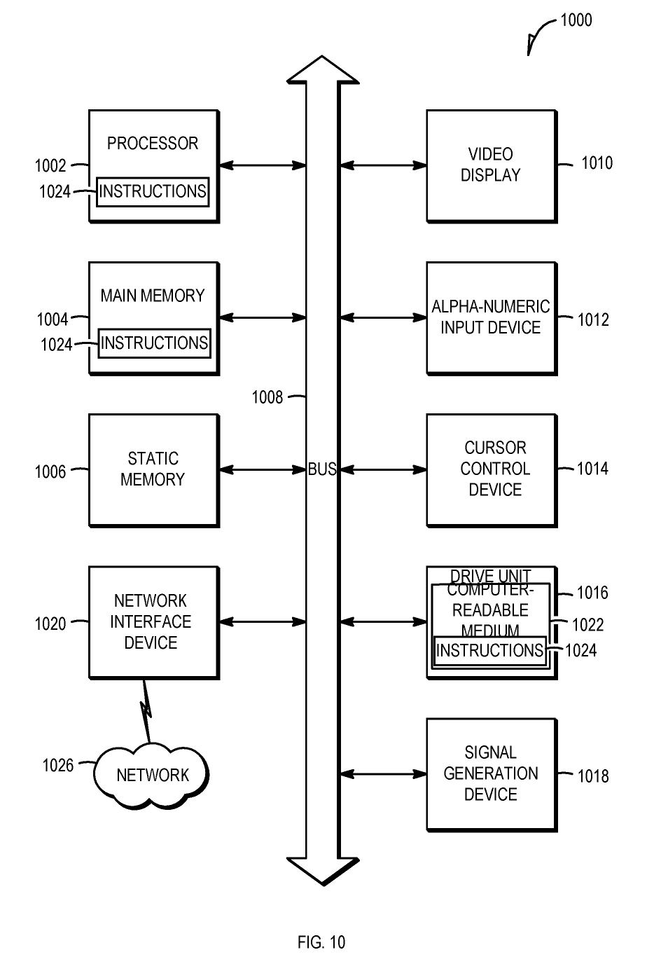

FIG. 1 is a block diagram illustrating an example of a network environment suitable for an augmented or mixed reality system, according to some example embodiments. A network environment 100 includes a mobile device 112 and a server 110, communicatively coupled to each other via a network 108. The mobile device 112 and the server 110 may each be implemented in a computer system, in whole or in part, as described below with respect to FIG. 10.

The server 110 may be part of a network-based system. For example, the network-based system may be or include a cloud-based server system that provides additional information, such as 3D models or other virtual objects, to the mobile device 112.

A user 102 may use or wear the mobile device 112 and look at a physical object 120 in a real world physical environment 101. The user 102 may be a human user (e.g., a human being), a machine user (e.g., a computer configured by a software program to interact with the mobile device 112), or any suitable combination thereof (e.g., a human assisted by a machine or a machine supervised by a human). The user 102 is not part of the network environment 100, but is associated with the mobile device 112. For example, the mobile device 112 may be a computing device with a camera and a transparent display such as a tablet, smartphone, or a wearable computing device (e.g., helmet or glasses). In another example embodiment, the computing device may be hand held or may be removably mounted to the head of the user 102. In one example, the display may be a screen that displays what is captured with a camera of the mobile device 112. In another example, the display of the mobile device 112 may be transparent or partially transparent such as in lenses of wearable computing glasses or the visor or a face shield of a helmet.

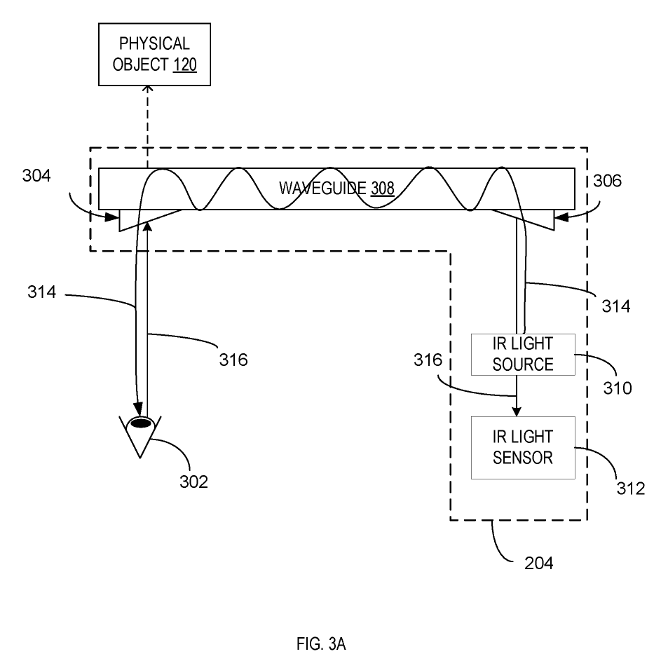

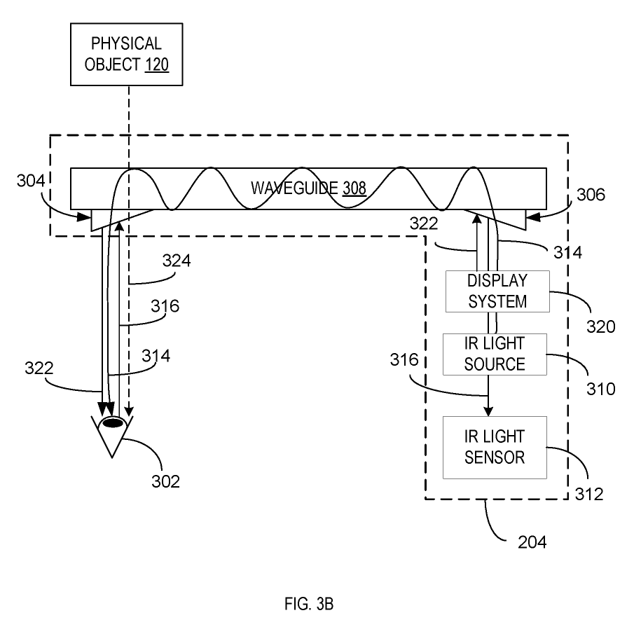

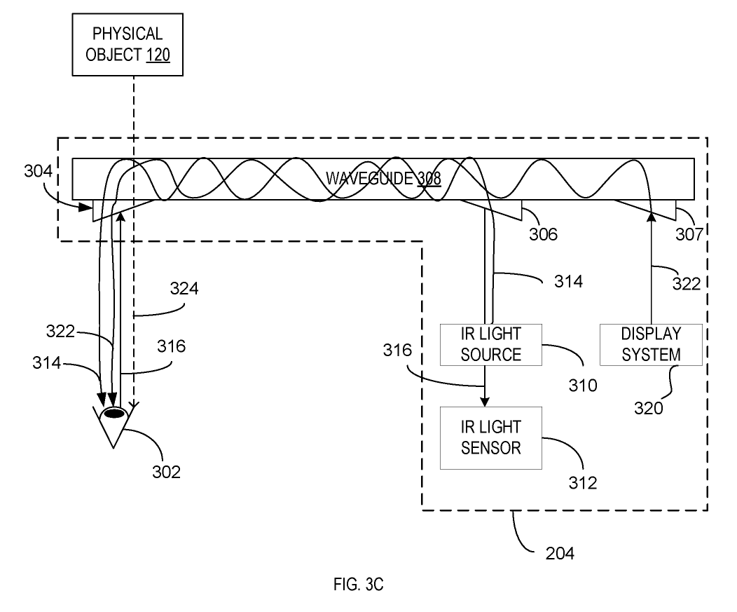

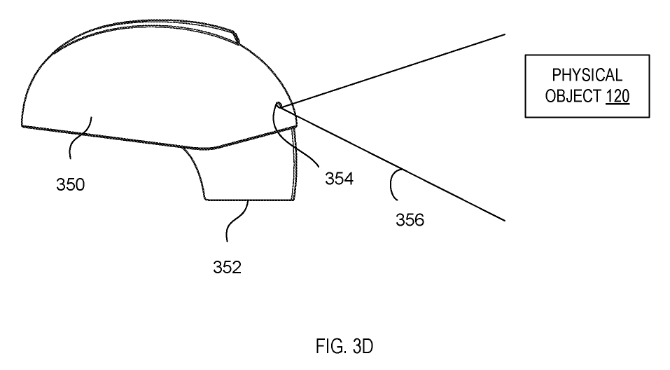

The mobile device 112 may track an eye gaze of the user (e.g., a position, a direction of movement, a movement of a pupil of the eye of the user). In one example embodiment, the mobile device 112 makes use of a transparent near eye lens positioned in front of the eye of the user. An example embodiment of the transparent near eye lens arrangement is described in more detail below with respect to FIGS. 3A-3C.

The user 102 may be a user of an AR application in the mobile device 112 and at the server 110. The AR application may provide the user 102 with an AR experience triggered by identified objects (e.g., physical object 120) in the physical environment 101. For example, the physical object 120 include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment. The AR application may include computer vision recognition to determine corners, objects, lines, letters, etc.

In one example embodiment, the AR application generates virtual objects based on the position or movement of the eye of the user 102. For example, if the user is looking straight, a first virtual object associated with the physical object 120 is rendered and displayed. In another example, if the user is looking to the left of the physical object 120, the AR application generates a second virtual object associated with the physical object 120. In another example, if the user is looking down, the AR application generates a third virtual object (related or not related to the physical object 120). In yet another example, if the user is looking up and down, the AR application generates a fourth virtual object (related or not related to the physical object 120).

In one example embodiment, the objects in the image are tracked and recognized locally in the mobile device 112 using a local context recognition dataset or any other previously stored dataset of the AR application of the mobile device 112. The local context recognition dataset module may include a library of virtual objects associated with real-world physical objects or references. In one example, the mobile device 112 identifies feature points in an image of the physical object 120. The mobile device 112 may also identify tracking data related to the physical object 120 (e.g., GPS location of the mobile device 112, orientation, distance to the physical object 20). If the captured image is not recognized locally at the mobile device 112, the mobile device 112 can download additional information (e.g., 3D model or other augmented data) corresponding to the captured image, from a database of the server 110 over the network 108.

In another example embodiment, the physical object 120 in the image is tracked and recognized remotely at the server 110 using a remote context recognition dataset or any other previously stored dataset of an AR application in the server 110. The remote context recognition dataset module may include a library of virtual objects or augmented information associated with real-world physical objects or references.

External sensors 118 may be associated with, coupled to, related to the physical object 120 to measure a location, status, and characteristics of the physical object 120. Examples of measured readings may include and but are not limited to weight, pressure, temperature, velocity, direction, position, intrinsic and extrinsic properties, acceleration, and dimensions. For example, external sensors 118 may be disposed throughout a factory floor to measure movement, pressure, orientation, and temperature. The external sensors 118 can also be used to measure a location, status, and characteristics of the mobile device 112 and the user 102. The server 110 can compute readings from data generated by the external sensors 118. The server 110 can generate virtual indicators such as vectors or colors based on data from external sensors 118. Virtual indicators are then overlaid on top of a live image or a view of the physical object 120 in a line of sight of the user 102 to show data related to the physical object 120. For example, the virtual indicators may include arrows with shapes and colors that change based on real-time data. The visualization may be provided to the physical object 120 so that the mobile device 112 can render the virtual indicators in a display of the mobile device 112. In another example embodiment, the virtual indicators are rendered at the server 110 and streamed to the mobile device 112. In another example embodiment, the virtual indicators may be displayed based on a position of the eye of the user. For example, if the user 102 is looking towards the top of physical object 120, the visual indicator may include a temperature of the physical object 120. If the user 102 is looking at the bottom of the physical object 120, the visual indicator may include an operating status of the physical object 120.

The external sensors 118 may include other sensors used to track the location, movement, and orientation of the mobile device 112 externally without having to rely on sensors internal to the mobile device 112. The external sensors 118 may include optical sensors (e.g., depth-enabled 3D camera), wireless sensors (Bluetooth, Wi-Fi), GPS sensors, and audio sensors to determine the location of the user 102 using the mobile device 112, distance of the user 102 to the external sensors 118 (e.g., sensors placed in corners of a venue or a room), the orientation of the mobile device 112 to track what the user 102 is looking at (e.g., direction at which the mobile device 112 is pointed, e.g., mobile device 112 pointed towards a player on a tennis court, mobile device 112 pointed at a person in a room within the physical environment 101).

In another example embodiment, data from the external sensors 118 and internal sensors in the mobile device 112 may be used for analytics data processing at the server 110 (or another server) for analysis on usage and how the user 102 is interacting with the physical object 120 in the physical environment 101. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 used the mobile device 112 when looking at the physical or virtual object, which features of the virtual object the user 102 interacted with (e.g., such as whether the user 102 engaged with the virtual object), and any suitable combination thereof. The mobile device 112 receives a visualization content dataset related to the analytics data. The mobile device 112 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., mobile device 112). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

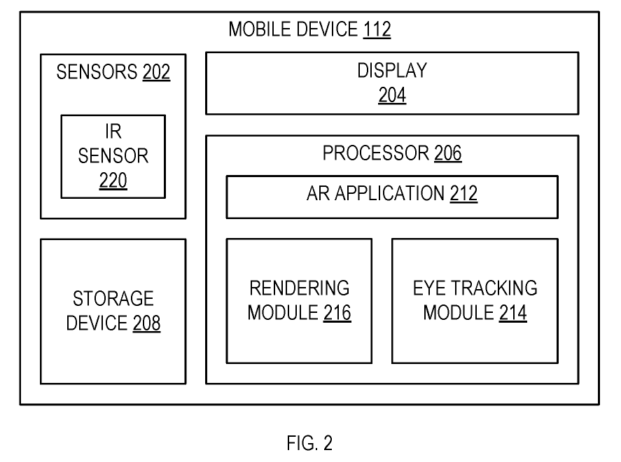

FIG. 2 is a block diagram illustrating an example embodiment of modules (e.g., components) of the mobile device 112. The mobile device 112 (e.g., a helmet, a visor, or any other device can be worn by the user 102) includes sensors 202, a display 204, a processor 206, and a storage device 208. The display 204 may include a transparent near eye lens that tracks the position of the eye of the user by generates an infrared light signal projected onto a transparent lens. The lens also collects infrared light reflected off the eye of the user 102.

The sensors 202 include, for example, a thermometer, an infrared camera, a barometer, a humidity sensor, an EEG sensor, a proximity or location sensor (e.g, near field communication, GPS, Bluetooth, Wifi), an optical sensor (e.g., a camera, an infrared sensor 220), an orientation sensor (e.g., gyroscope), an accelerometer, an audio sensor (e.g., a microphone), or any suitable combination thereof. It is noted that the types of sensors described herein are for illustration purposes and the sensors 202 are thus not limited to the ones described.

The processor 206 includes an AR application 212, a rendering module 216, and an eye tracking module 214. The AR application 212 receives data from sensors 202 (e.g., receive an image of the physical object 104) and identifies and recognizes the physical object 120 using machine-vision recognition techniques. The AR application 212 then retrieves, from the storage device 208, AR content associated with the physical object 120. In one example embodiment, the AR application 212 identifies a visual reference (e.g., a logo or QR code) on the physical object (e.g., a chair) and tracks the visual reference. The visual reference may also be referred to as a marker and may consist of an identifiable image, symbol, letter, number, machine-readable code. For example, the visual reference may include a bar code, a quick response (QR) code, or an image that has been previously associated with the virtual object.

In another example embodiment, the AR application 212 receives data from the eye tracking module 214. For example, the eye tracking module 214 may identify a direction of an eye gaze of the user 102. The AR application 212 then retrieves, from the storage device 208, AR content associated with a combination of the recognized physical object 120 and the direction of the eye gaze of the user 102. In another example embodiment, the AR application 212 first retrieves AR content associated with the physical object 120 and modifies the AR content based on a direction, a position, a movement, a duration, or a combination thereof of the eye gaze of the user 102.

The eye tracking module 214 controls an infrared light source directed at the eye of the user via optical couplers connected to a transparent waveguide. The arrangement of the optical couplers and transparent waveguide for a display lens or display 204 is described in more detail below with respect to FIGS. 3A-3C. The eye tracking module 214 receives reflection data from an imaging system such as an infrared light detector to detect infrared light reflected from the eye of the user 102 via the optical couplers and the transparent waveguide. The eye tracking module 214 operates on the reflection data to identify a position of the eye of the user 102. For example, the eye tracking module 214 performs an algorithm on the reflection data to extrapolate the position of the eye of the user. For example, the location of reflected infrared light within the optical coupler corresponds to a position of the eye of the user. The infrared light is directed towards the center of the eye or pupil and causes a reflection in the cornea. That reflection is tracked by the IR camera. The information is then analyzed to extract eye rotation from changes in reflections. The eye tracking module includes for example a video-based eye trackers that typically use the corneal reflection and the center of the pupil as features to track over time. A more sensitive type of eye tracker uses reflections from the front of the cornea and the back of the lens as features to track. A still more sensitive method of tracking is to image features from inside the eye, such as the retinal blood vessels, and follow these features as the eye rotates.

The reflection of the IR illumination is dependent upon the user's gaze. As the user changes their eye position, the location and number of reflected points will change. The movement of the reflected points corresponds to a change in location where the users gaze has moved. The reflected light from each eye is used to correlate the positional change in gaze and reduces the error from the algorithm.

The rendering module 216 renders virtual objects based on data from sensors 202. For example, the rendering module 216 renders a display of a virtual object (e.g., a door with a color based on the temperature inside the room as detected by sensors from HMDs inside the room) based on a three-dimensional model of the virtual object (e.g., 3D model of a virtual door) associated with the physical object 120 (e.g., a physical door). In another example, the rendering module 216 generates a display of the virtual object overlaid on an image of the physical object 120 captured by a camera of the mobile device 112. The virtual object may be further manipulated (e.g., by the user 102) by moving the physical object 120 relative to the mobile device 112. Similarly, the display of the virtual object may be manipulated (e.g., by the user 102) by moving the mobile device 112 relative to the physical object 120.

In one example embodiment, the rendering module 216 identifies the physical object 120 (e.g., a physical telephone) based on data from sensors 202 and external sensors 118, accesses virtual functions (e.g., increase or lower the volume of a nearby television) associated with physical manipulations (e.g., lifting a physical telephone handset) of the physical object 120, and generates a virtual function corresponding to a physical manipulation of the physical object 120.

In another example embodiment, the rendering module 216 determines whether the captured image matches an image locally stored in the storage device 208 that includes a local database of images and corresponding additional information (e.g., three-dimensional model and interactive features). The rendering module 216 retrieves a primary content dataset from the server 110, generates and updates a contextual content dataset based on an image captured with the mobile device 112.

The storage device 208 stores an identification of the sensors and their respective functions. The storage device 208 further includes a database of visual references (e.g., images, visual identifiers, features of images) and corresponding experiences (e.g., three-dimensional virtual objects, interactive features of the three-dimensional virtual objects). For example, the visual reference may include a machine-readable code or a previously identified image (e.g., a picture of shoe). The previously identified image of the shoe may correspond to a three-dimensional virtual model of the shoe that can be viewed from different angles by manipulating the position of the mobile device 112 relative to the picture of the shoe. Features of the three-dimensional virtual shoe may include selectable icons on the three-dimensional virtual model of the shoe. An icon may be selected or activated using a user interface on the mobile device 112.

In another example embodiment, the storage device 208 includes a primary content dataset, a contextual content dataset, and a visualization content dataset. The primary content dataset includes, for example, a first set of images and corresponding experiences (e.g., interaction with three-dimensional virtual object models). For example, an image may be associated with one or more virtual object models. The primary content dataset may include a core set of images of the most popular images determined by the server 110. The core set of images may include a limited number of images identified by the server 110. For example, the core set of images may include the images depicting covers of the ten most popular magazines and their corresponding experiences (e.g., virtual objects that represent the ten most popular magazines or physical objects within the physical environment 101). In another example, the server 110 may generate the first set of images based on the most popular or often scanned images received at the server 110. Thus, the primary content dataset does not depend on objects or images scanned by the rendering module 216.

The contextual content dataset includes, for example, a second set of images and corresponding experiences (e.g., three-dimensional virtual object models) retrieved from the server 110. For example, images captured with the mobile device 112 that are not recognized (e.g., by the server 110) in the primary content dataset are submitted to the server 110 for recognition. If the captured image is recognized by the server 110, a corresponding experience may be downloaded at the mobile device 112 and stored in the contextual content dataset. Thus, the contextual content dataset relies on the context in which the mobile device 112 has been used. As such, the contextual content dataset depends on objects or images scanned by the rendering module 214 of the mobile device 112.

In one embodiment, the mobile device 112 may communicate over the network 108 with the server 110 to retrieve a portion of a database of visual references, corresponding three-dimensional virtual objects, and corresponding interactive features of the three-dimensional virtual objects. The network 108 may be any network that enables communication between or among machines, databases, and devices (e.g., the mobile device 112). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

FIG. 3A is a block diagram illustrating a first example embodiment of a display system. The display 204 includes a transparent waveguide 308, a first optical coupler 304, a second optical coupler 306, an infrared light source 310, and an infrared light sensor 312 (e.g., an IR sensor). The transparent waveguide 308 includes a transparent optical planar physical structure that guides visible and non-visible light. The first and second optical couplers 304, 306 are attached to a same side of the transparent waveguide 308 and are configured to receive and transmit light to and from the transparent waveguide 308. For example, the first and second optical couplers 304, 306 are connected to the side of the transparent waveguide 308 facing the eye 302 of the user 102. The first optical coupler 304 is adjacent and positioned in front of the eye 302. A line of sight is formed from the eye 302 through the first optical coupler 304 and the waveguide 308 towards the physical object 120. The second optical coupler 306 is connected to an end of the transparent waveguide 308 adjacent to the infrared light source 310.

The infrared light source 310 generates infrared light 314 at the second optical coupler 306. The infrared light 314 from the infrared light source 310 travels through the transparent waveguide until it exists through the first optical coupler 306. The infrared light 314 exiting the first optical coupler 304 shines into the eye 302 of the user 102. The infrared light 314 is reflected off the pupil of the eye 302. The reflected infrared light 316 travels back into the first optical coupler 304 through the transparent waveguide 308 and exists through the second optical coupler 306. The infrared light sensor 312 detects the reflected infrared light 316 and generates reflection data corresponding to the reflected infrared light 316 received at the infrared light sensor 312. It is noted that the infrared light sensor 312 does not interfere with the infrared light source 310 since the infrared light sensor 312 is placed behind the infrared light source 310. The infrared light sensor 312 sends the reflection data to the eye tracking module 214 for further processing to determine the position of the eye of the user based on the reflection data.

FIG. 3B is a block diagram illustrating a second example embodiment of a display system. The display 204 includes the transparent waveguide 308, the first optical coupler 304, the second optical coupler 306, the infrared light source 310, the infrared light sensor 312 (e.g., an IR sensor), and a display system 320. The transparent waveguide 308 includes a transparent optical planar physical structure that guides light. The first and second optical couplers 304, 306 are attached to the same side of the transparent waveguide 308 and are configured to receive and transmit light to and from the transparent waveguide 308. For example, the first and second optical couplers 304, 306 are connected to the side of the transparent waveguide 308 facing the eye 302 of the user 102. The first optical coupler 304 is adjacent and positioned in front of the eye 302. The second optical coupler 306 is connected to an end of the transparent waveguide 308 adjacent to the infrared light source 310.

The infrared light source 310 generates infrared light 314 at the second optical coupler 306. The infrared light 314 from the infrared light source 310 travels through the transparent waveguide until it exists through the first optical coupler 306. The infrared light 314 exiting the first optical coupler 304 shines into the eye 302 of the user 102. The infrared light 314 is reflected off the pupil of the eye 302. The reflected infrared light 316 travels back into the first optical coupler 304 through the transparent waveguide 308 and exists through the second optical coupler 306. The infrared light sensor 312 detects the reflected infrared light 316 and generates reflection data corresponding to the reflected infrared light 316 received at the infrared light sensor 312. The infrared light sensor 312 sends the reflection data to the eye tracking module 214 for further processing to determine the position of the eye of the user based on the reflection data.

The display system 320 generates visible light 322 to form an image of a virtual object based on the AR application 212. The display system 320 directs the visible light 322 into the same second optical coupler 306. The placement of the display system 320 is such that it does not interfere with the infrared light sensor 312. The visible light 322 travels through the transparent waveguide 308 and exits through the first optical coupler 304 to the eye 302. Light 324 reflected from the physical object 120 travels through the transparent waveguide 308 and the first optical coupler 304 to the eye 302.

FIG. 3C is a block diagram illustrating a third example embodiment of a display system. The display 204 includes the transparent waveguide 308, the first optical coupler 304, the second optical coupler 306, a third optical coupler 307, the infrared light source 310, the infrared light sensor 312 (e.g., an IR sensor), and the display system 320.

The transparent waveguide 308 includes a transparent optical planar physical structure that guides light. The first, second, and third optical couplers 304, 306, 307 are attached to the same side of the transparent waveguide 308 and are configured to receive and transmit light to and from the transparent waveguide 308. For example, the first optical coupler 304 is adjacent to the eye 302. The second optical coupler 306 is adjacent to the infrared light source 310. The third optical coupler is adjacent to the display system 320.

The infrared light source 310 generates infrared light 314 to the second optical coupler 306. The infrared light 314 from the infrared light source 310 travels through the transparent waveguide until it exists through the first optical coupler 306. The infrared light 314 exiting the first optical coupler 304 shines into the eye 302 of the user 102. The infrared light 314 is reflected off the pupil of the eye 302. The reflected infrared light 316 travels back into the first optical coupler 304 through the transparent waveguide 308 and exists through the second optical coupler 306. The infrared light sensor 312 detects the reflected infrared light 316 and generates reflection data corresponding to the reflected infrared light 316 received at the infrared light sensor 312. The infrared light sensor 312 sends the reflection data to the eye tracking module 214 for further processing to determine the position of the eye of the user based on the reflection data.

The display system 320 generates visible light 322 to form an image of a virtual object based on the AR application 212. The display system 320 directs the visible light 322 into the third optical coupler 306. The visible light 322 travels through the transparent waveguide 308 and exits through the first optical coupler 304 to the eye 302. Light 324 reflected from the physical object 120 travels through the transparent waveguide 308 and the first optical coupler 304 to the eye 302.

FIG. 3D is a block diagram illustrating an example embodiment of a head mounted device 350 with a transparent near eye lens. The head mounted device 350 may include a helmet with a transparent visor 352. The display 204 may be formed as part of the transparent visor 352. In another example, the display 204 may be separate and adjacent to the transparent visor 352. A camera 354 may be disposed in a frontal portion of the head mounted device 350. The camera 354 captures an image of the physical object 120 within a field of view 356 of the camera 354.

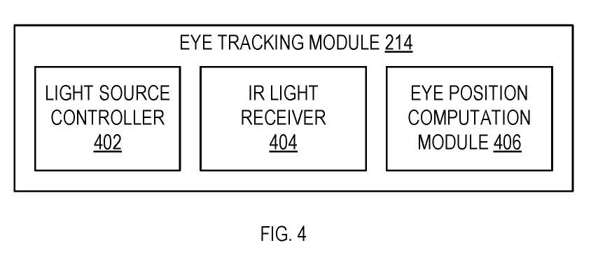

FIG. 4 is a block diagram illustrating an example embodiment of the eye tracking module 214. The light source controller 402 controls the infrared light source 310. The infrared light receiver 404 communicates with the infrared light sensor 312 and receives reflection data from the infrared light sensor 312. The eye position computation module 406 performs a computation algorithm on the reflection data to determine and identify the position (movement or direction of a gaze) of the eye 302.

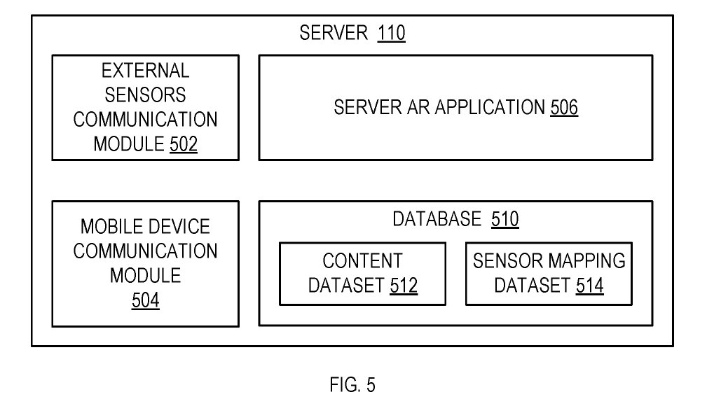

FIG. 5 is a block diagram illustrating an example embodiment of a server. The server 110 includes external sensors communication module 502, a mobile device communication module 504, a server AR application 506, and a database 510.

The external sensors communication module 502 communicates, interfaces with, and accesses data from the external sensors 118. The mobile device communication module 504 communicates, interfaces with, and accesses data from the mobile device 112. The server AR application 506 operates in a similar manner to AR application 212 of mobile device 112.

The database 510 stores a content dataset 512 and a sensor mapping dataset 514. The content dataset 512 may store a primary content dataset and a contextual content dataset. The primary content dataset comprises a first set of images and corresponding virtual object models. The server AR application 506 determines that a captured image received from the mobile 112 is not recognized in the content dataset 512, and generates the contextual content dataset for the mobile 112. The contextual content dataset may include a second set of images and corresponding virtual object models. The virtual content dataset includes models of virtual objects to be generated upon receiving a notification associated with an image of a corresponding physical object 120. The sensor mapping dataset 514 includes identifications, specifications, and locations of the external sensors 118.

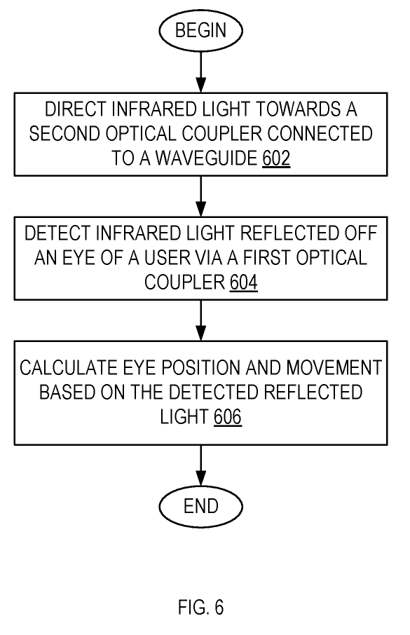

FIG. 6 is a flow diagram illustrating a method for calculating an eye position using a transparent near eye lens in accordance with one embodiment. At operation 602, the light source controller 402 directs the infrared light source 310 to shine infrared light towards a second optical coupler connected to a transparent waveguide. At operation 604, the infrared light receiver 404 uses the infrared light sensor 312 to detect infrared light reflected off the eye of the user via a first optical coupler. At operation 606, the eye position computation module 406 computes the eye position and movement based on the detected infrared light reflected off the eye of the user.

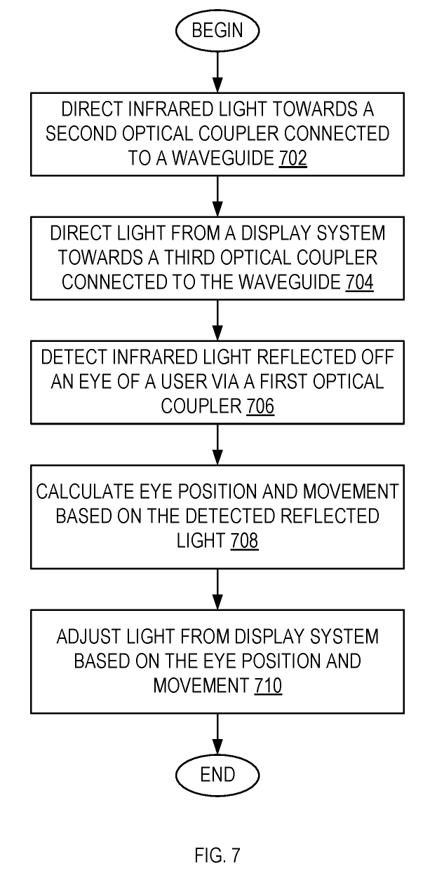

FIG. 7 is a flow diagram illustrating a method for displaying a hologram based on an eye position using a transparent near eye lens in accordance with one embodiment. At operation 702, the light source controller 402 directs the infrared light source 310 to shine infrared light towards a second optical coupler connected to a transparent waveguide. At operation 704, a display system directs visible light to shine towards a third optical coupler connected to the transparent waveguide. At operation 706, the infrared light receiver 404 uses the infrared light sensor 312 to detect infrared light reflected off the eye of the user via a first optical coupler. At operation 708, the eye position computation module 406 computes the eye position and movement based on the detected infrared light reflected off the eye of the user. At operation 710, the AR application 212 adjust the visible light from the display system based on the eye position and movement.

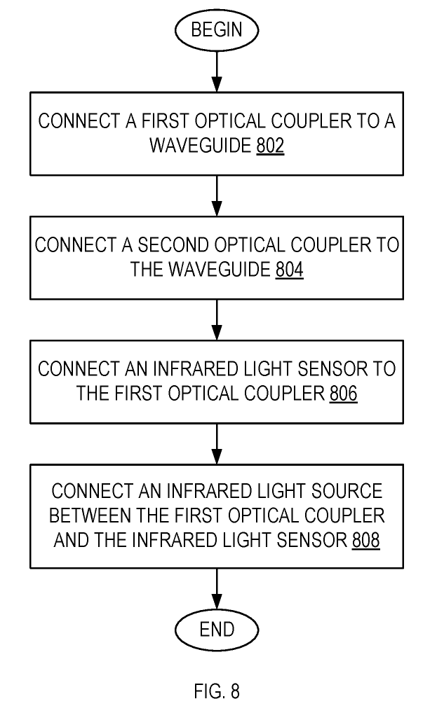

FIG. 8 is a flow diagram illustrating a method for manufacturing a transparent near eye lens in accordance with one embodiment. At operation 802, a first optical coupler is connected to a first end of a transparent waveguide. At operation 804, a second optical coupler is connected to a second end of the transparent waveguide. At operation 806, an infrared light sensor is coupled to the second optical coupler. At operation 808, an infrared light source is positioned between the infrared light sensor and the second optical coupler.

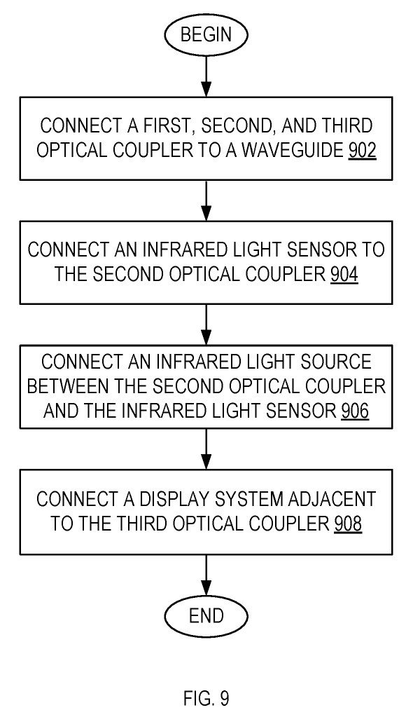

FIG. 9 is a flow diagram illustrating another method for manufacturing a display system with a transparent near eye lens in accordance with one embodiment. At operation 902, a first, second, and third optical coupler are connected to a transparent waveguide. At operation 904, an infrared light sensor is connected to the second optical coupler. At operation 906, an infrared light source is positioned between the infrared light sensor and the second optical coupler. At operation 908, a display system is connected to the third optical coupler.

### Example Machine

FIG. 10 is a block diagram illustrating components of a machine 1000, according to some example embodiments, able to read instructions 1006 from a computer-readable medium 1018 (e.g., a non-transitory machine-readable medium, a machine-readable storage medium, a computer-readable storage medium, or any suitable combination thereof) and perform any one or more of the methodologies discussed herein, in whole or in part. Specifically, the machine 1000 in the example form of a computer system (e.g., a computer) within which the instructions 1006 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be communicatively coupled (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1006, sequentially or otherwise, that specify actions to be taken by that machine. Further, while only a single machine is illustrated, the term “machine” shall also be taken to include any collection of machines that individually or jointly execute the instructions 1006 to perform all or part of any one or more of the methodologies discussed herein.

The machine 1000 includes a processor 1004 (e.g., a CPU, a graphics processing unit (GPU), a digital signal processor (DSP), an ASIC, a radio-frequency integrated circuit (RFIC), or any suitable combination thereof), a main memory 1010, and a static memory 1022, which are configured to communicate with each other via a bus 1012. The processor 1004 contains solid-state digital microcircuits (e.g., electronic, optical, or both) that are configurable, temporarily or permanently, by some or all of the instructions 1006 such that the processor 1004 is configurable to perform any one or more of the methodologies described herein, in whole or in part. For example, a set of one or more microcircuits of the processor 1004 may be configurable to execute one or more modules (e.g., software modules) described herein. In some example embodiments, the processor 1004 is a multicore CPU (e.g., a dual-core CPU, a quad-core CPU, or a 128-core CPU) within which each of multiple cores behaves as a separate processor that is able to perform any one or more of the methodologies discussed herein, in whole or in part. Although the beneficial effects described herein may be provided by the machine 1000 with at least the processor 1004, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1000 may further include a video display 1008 (e.g., a plasma display panel (PDP), a light emitting diode (LED) display, a liquid crystal display (LCD), a projector, a cathode ray tube (CRT), or any other display capable of displaying graphics or video). The machine 1000 may also include an alpha-numeric input device 1014 (e.g., a keyboard or keypad), a cursor control device 1016 (e.g., a mouse, a touchpad, a trackball, a joystick, a motion sensor, an eye tracking device, or other pointing instrument), a drive unit 1002, a signal generation device 1020 (e.g., a sound card, an amplifier, a speaker, a headphone jack, or any suitable combination thereof), and a network interface device 1024.

The drive unit 1002 (e.g., a data storage device) includes the computer-readable medium 1018 (e.g., a tangible and non-transitory machine-readable storage medium) on which are stored the instructions 1006 embodying any one or more of the methodologies or functions described herein. The instructions 1006 may also reside, completely or at least partially, within the main memory 1010, within the processor 1004 (e.g., within the processor's cache memory), or both, before or during execution thereof by the machine 1000. Accordingly, the main memory 1010 and the processor 1004 may be considered machine-readable media (e.g., tangible and non-transitory machine-readable media). The instructions 1006 may be transmitted or received over a computer network 1026 via the network interface device 1024. For example, the network interface device 1024 may communicate the instructions 1006 using any one or more transfer protocols (e.g., hypertext transfer protocol (HTTP)).

In some example embodiments, the machine 1000 may be a portable computing device (e.g., a smart phone, tablet computer, or a wearable device), and have one or more additional input components (e.g., sensors or gauges). Examples of such input components include an image input component (e.g., one or more cameras), an audio input component (e.g., one or more microphones), a direction input component (e.g., a compass), a location input component (e.g., a GPS receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the computer-readable medium 1018 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1006 for execution by the machine 1000, such that the instructions 1006, when executed by one or more processors of the machine 1000 (e.g., processor 1004), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1006 for execution by the machine 1000 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1006).

### Example Mobile Device

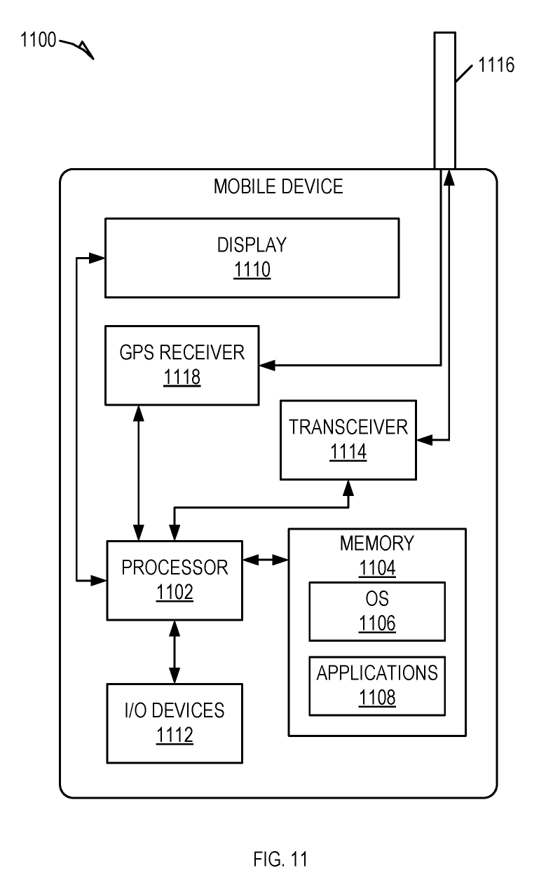

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user 102. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over suitable circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following embodiments describe various example embodiments of methods, machine-readable media, and systems (e.g., machines, devices, or other apparatus) discussed herein.

### Examples

A first example provides a head mounted device comprising:

a transparent display having a transparent waveguide and a first and second optical component, the first and second optical component being connected to the transparent waveguide;

an infrared light source coupled to the transparent display, the infrared light source configured to generate an infrared light directed at the second optical component, the transparent waveguide configured to receive the infrared light from the second optical component and to transmit the infrared light to the first optical component, the first optical component configured to direct the infrared light to an eye of a user of the head mounted device and receive a reflection of the infrared light off the eye of the user;

an infrared light receiver configured to receive the reflection of the infrared light via the second optical component and to generate reflection data based on the received reflection of the infrared light; and

one or more hardware processor comprising an eye tracking application, the eye tracking application configured to perform operations comprising: receiving the reflection data from the infrared light receiver, and identifying a position of the eye of the user based on the reflection data.

A second example provides a head mounted device according to any one of the above examples, further comprising:

The head mounted device of claim 1, wherein the transparent waveguide includes an elongated member having a first planar side and a second planar side opposite and parallel to the first planar side, the elongated member having a first end and a second end opposite to the first end, the first optical component connected to the first end of the elongated member on the first planar side, the second optical component connected to the second end of the elongated member on the first planar side.

A third example provides a head mounted device according to any one of the above examples, wherein the infrared light source and the infrared light receiver are coupled to the second optical component on the first planar side of the transparent guide.

A fourth example provides a head mounted device according to any one of the above examples, further comprising:

an augmented reality display system coupled to the transparent display, the augmented reality display system comprising a second light source directed at the second optical component, the second light source configured to generate a light having a wavelength different from the infrared light, the second light source configured to generate the light based on an augmented reality object to be displayed in the transparent display.

A fifth example provides a head mounted device according to any one of the above examples, wherein the one or more hardware processor further comprises:

an augmented reality application configured to perform operations comprising: generating the augmented reality object and communicating the augmented reality object to the display system.

A sixth example provides a head mounted device according to any one of the above examples, further comprising:

an augmented reality application configured to perform operations comprising: generating the augmented reality object based on the position of the eye of the user, and communicating the augmented reality object to the display system.

A seventh example provides a head mounted device according to any one of the above examples, wherein the eye tracking application is configured to identify a movement of the eye of the user based on changes in the reflection data.

An eighth example provides a head mounted device according to any one of the above examples, further comprising:

an augmented reality application configured to perform operations comprising: generating the augmented reality object based on the movement of the eye of the user, and communicating the augmented reality object to the display system.

A ninth example provides a head mounted device according to any one of the above examples, further comprising:

a third optical component connected to the second end of the elongated member on the first planar side, the third optical component being adjacent to the second optical component; and

an augmented reality display system coupled to the third optical component, the display system configured to generate a second light source directed at the third optical component, the second light source configured to generate a light having a wavelength different from the infrared light, the second light source configured to generate the light based on an augmented reality object to be displayed.

A tenth example provides a head mounted device according to any one of the above examples, wherein the first and second optical components include at least of one a prism, a lens, and a hologram.

What is claimed is:

1. A head mounted device comprising:
a transparent display having a transparent waveguide and a first and second optical component, the first and second optical component being connected to the transparent waveguide;
an infrared light source coupled to the transparent display, the infrared light source configured to generate an infrared light directed at the second optical component, the transparent waveguide configured to receive the infrared light from the second optical component and to transmit the infrared light to the first optical component, the first optical component configured to direct the infrared light to an eye of a user of the head mounted device and receive a reflection of the infrared light off the eye of the user;
an infrared light receiver configured to receive the reflection of the infrared light via the second optical component and to generate reflection data based on the received reflection of the infrared light; and
one or more hardware processor comprising an eye tracking application, the eye tracking application configured to perform operations comprising: receiving the reflection data from the infrared light receiver, and identifying a position of the eye of the user based on the reflection data.

2. The head mounted device of claim 1, wherein the transparent waveguide includes an elongated member having a first planar side and a second planar side opposite and parallel to the first planar side, the elongated member having a first end and a second end opposite to the first end, the first optical component connected to the first end of the elongated member on the first planar side, the second optical component connected to the second end of the elongated member on the first planar side.

3. The head mounted device of claim 2, wherein the infrared light source and the infrared light receiver are coupled to the second optical component on the first planar side of the transparent guide.

4. The head mounted device of claim 1, further comprising:
an augmented reality display system coupled to the transparent display, the augmented reality display system comprising a second light source directed at the second optical component, the second light source configured to generate a light having a wavelength different from the infrared light, the second light source configured to generate the light based on an augmented reality object to be displayed in the transparent display.

5. The head mounted device of claim 4, wherein the one or more hardware processor further comprises:
an augmented reality application configured to perform operations comprising: generating the augmented reality object and communicating the augmented reality object to the display system.

6. The head mounted device of claim 4, wherein the one or more hardware processor further comprises:
an augmented reality application configured to perform operations comprising: generating the augmented reality object based on the position of the eye of the user, and communicating the augmented reality object to the display system.

7. The head mounted device of claim 4, wherein the eye tracking application is configured to identify a movement of the eye of the user based on changes in the reflection data.

8. The head mounted device of claim 7, wherein the one or more hardware processor further comprises:
an augmented reality application configured to perform operations comprising: generating the augmented reality object based on the movement of the eye of the user, and communicating the augmented reality object to the display system.

9. The head mounted device of claim 2, further comprising:
a third optical component connected to the second end of the elongated member on the first planar side, the third optical component being adjacent to the second optical component; and
an augmented reality display system coupled to the third optical component, the display system configured to generate a second light source directed at the third optical component, the second light source configured to generate a light having a wavelength different from the infrared light, the second light source configured to generate the light based on an augmented reality object to be displayed.

10. The head mounted device of claim 1, wherein the first and second optical components include at least of one a prism, a lens, and a hologram.

11. A method comprising:
generating an infrared light with an infrared light source directed at a second optical component of a transparent display, the transparent display having a transparent waveguide, and a first optical component and the second optical component connected to the transparent waveguide, the transparent waveguide configured to receive the infrared light from the second optical component and to transmit the infrared light to the first optical component, the first optical component configured to direct the infrared light to an eye of a user of a head mounted device and to receive a reflection of the infrared light off the eye of the user;
receiving, at an infrared light receiver, the reflection of the infrared light via the second optical component;
generating, using one or more hardware processor, reflection data based on the received reflection of the infrared light; and
identifying a position of the eye of the user based on the reflection data.

12. The method of claim 11, wherein the transparent waveguide includes an elongated member having a first planar side and a second planar side opposite and parallel to the first planar side, the elongated member having a first end and a second end opposite to the first end, the first optical component connected to the first end of the elongated member on the first planar side, the second optical component connected to the second end of the elongated member on the first planar side.

13. The method of claim 12, wherein the infrared light source and the infrared light receiver are coupled to the second optical component on the first planar side of the transparent guide.

14. The method of claim 11, further comprising:
generating an augmented reality object with an augmented reality application implemented in the one or more hardware processor;
communicating the augmented reality object to a display system coupled to the transparent display; and
generating, with a second light source directed at the second optical component, a light having a wavelength different from the infrared light, the light generated based on the augmented reality object to be displayed in the transparent display, the second light source controlled by the display system.

15. The method of claim 14, wherein the augmented reality object includes virtual content generated based on a direction of a gaze determined based on the position of the eye of the user.

16. The method of claim 14, further comprising:
identifying a movement of the eye of the user based on changes in the reflection data.

17. The method of claim 14, wherein the augmented reality object includes virtual content generated based on the movement of the eye of the user.

18. The method of claim 12, wherein the transparent display includes a third optical component connected to the second end of the elongated member on the first planar side, the third optical component being adjacent to the second optical component, an augmented reality display system coupled to the third optical component,
wherein the method further comprises:
generating, with a second light source directed at the third optical component, a light having a wavelength different from the infrared light, the second light source controlled by the augmented reality system and configured to generate the light based on an augmented reality object to be displayed.

19. The method of claim 11, wherein the first and second optical components include at least of one a prism, a lens, and a hologram.

20. A non-transitory computer-readable storage medium, the computer-readable storage medium including instructions that when executed by a computer, cause the computer to:
generating an infrared light with an infrared light source directed at a second optical component of a transparent display, the transparent display having a transparent waveguide, and a first optical component and the second optical component connected to the transparent waveguide, the transparent waveguide configured to receive the infrared light from the second optical component and to transmit the infrared light to the first optical component, the first optical component configured to direct the infrared light to an eye of a user of a head mounted device and to receive a reflection of the infrared light off the eye of the user;
receiving, at an infrared light receiver, the reflection of the infrared light via the second optical component;
generating, using one or more hardware processor, reflection data based on the received reflection of the infrared light; and
identifying a position of the eye of the user based on the reflection data.
